(19) United States
(12) Patent Application Publication
(10) Pub. No.: US 2007/0256350 A1
(43) Pub. Date: Nov. 8, 2007

(54) Apparatus and method to intercept and interdict subterranean termites using miscible tasks

(76) Inventor: Jerry Cates, Round Rock, TX (US)

Correspondence Address: Robert C. Klinger, 3999 Touraine, Frisco, TX, 75034, US

(21) Appl. No.: 11/429,692

(22) Filed: May 8, 2006

(51) Int. Cl. A01M 17/00; A01M 1/20

(52) U.S. Cl. 43/132.1; 43/131

(57) ABSTRACT

Herein is disclosed an apparatus for intercepting and interdicting target organisms such as subterranean termites, which apparatus is comprised of an outer shell fitted with a port for organism ingress and egress and a dorsal cover fitted with a signal port for visual inspections. Inside are materials suitable as food for the organisms targeted by the device, so arranged and comprised as to aid and encourage the habitation, propagation, and retention of biological pesticides, including entomopathogenic nematodes. The subject invention teaches a method of gradually deploying its apparatus to intercept the presence, measure the strength and vigor, and interdict aggregations, of said target organisms. The method permits minimal, systematic deployments that undergo progressive evolutions as information from each deployed device accumulates. Reliance on simple, accurate, visual signals, to determine servicing and supplementation requirements, reduces the user's inspection and servicing time, minimizes the use of interdiction agents, and speeds the interdiction of the targeted organism at the site.

### FIELD OF THE INVENTION

This invention relates to a family of devices that intercept certain eusocial insects such as subterranean termites. It also relates to the deployment of toxins, biological agents, or both, in such devices as a means of interdicting the superorganisms associated with such insects. It further discloses a simple task set that the disclosed design facilitates to enable installing, inspecting, and servicing a complete interdiction zone in parallel with general insect control services.

### BACKGROUND OF THE INVENTION

Eusocial Insects

Eusociality occurs in the insect orders Hymenoptera and Isoptera, and in the suborder Homoptera. Within these, all (Isoptera), many (Hymenoptera), or only a few (Homoptera) species exhibit true eusociality.

Eusocial insects, as distinct from solitary ones, have overlapping generations, cooperative brood care, and a division of labor in reproduction. Together, these characteristics have evolved into highly specialized super-organic structures that provide habitat, food, and a more or less regulated environment. Though individual members of truly eusocial insect species cannot long survive outside the confines of their communal structures, within them they are able to exploit their surroundings with amazing efficiency. When in close proximity to humans, many of the eusocial insects in the order Isoptera (the termites) pose significant threats to our buildings and objects that we cultivate, construct, utilize, and enjoy.

During the post-WW-II period and continuing until 1996, termite exterminators primarily used soil-drench methods that interposed a continuous barrier of soil toxicants between termite foragers and objects humans wish to protect from their infestations. Termite baiting, introduced in 1996, uses toxicant bait placed in detector/bait-server devices (interceptors) deployed around such objects to eradicate foraging termites in the vicinity. Though soil-drench methods are still in use, baiting is a preferred method because it requires only miniscule quantities of toxicant that users place in child and pet resistant containers, and its effects extend far beyond the small areas where users deploy its bait.

As practiced between 1996 and the present, termite baiting has been considerably more expensive and time consuming than competing soil-drench methods. Termite bait users require specialized training and, in many cases, specialized equipment to perform their work. Though the concepts involved are similar to those of general insect control services, termite baiting has not mixed well with them. As a rule, users typically perform and invoice termite baiting separately from other pest management work.

Interception

The expression “interception” has enjoyed a time-honored place in the annals of insect control. Glenn Esenther and Ray Beal applied it to termite control in the 1960's. An interceptor seizes specific target objects on their way to a defined objective: as used in this specification, the interceptor is a device containing materials that termites find suitable for food, and the intercepted objects are termites searching for food and habitat. In the sense used here, an interceptor attracts a termite's attention and entices a termite forager to enter it, but does not trap or restrain the organism. The objective of a termite interceptor design may be merely to detect the presence of termites, but most interceptors marketed today proceed to neutralize the termites they intercept, usually by poisoning them with a toxicant.

Superorganism Interdiction

Entomologists and pest management professionals use “colony suppression” and “colony elimination” to describe different methods, even different philosophies, of baiting for termite control. “Colony” refers to a body of organisms, usually a single species, operating autonomously in a habitat of its choosing. However, because the term is silent about the fortress-like structures that termites create for their protection and the fragility of those structures when any of their essential features are lost or eroded, it suffers from important inadequacies. Termites do not form simple colonies; their aggregations are true superorganisms complete with outer coverings that enclose a combination of reproductive, incubation, and brood care facilities, food acquisition, digestion, and distribution systems, and defensive forces.

In place of “colony,” this specification uses “superorganism.” The term embraces the organic, physical, and social structures associated with termites, particularly as those structures enable them to survive and thrive.

The terms “suppression” and “elimination,” as descriptors of termite control methods, focus primarily on the effects such methods have on individual termites. However, killing a few (suppression) or destroying them all (elimination) isn't the real objective. The goal is to interdict, that is, to disrupt the internal structure of the superorganism so that, by losing its essential cohesive character, it cannot pose a threat within the interdiction zone.

To interdict is to prohibit or forbid, with authority, a specific action, or the use of a specific thing. The focus is not on the actor, but on the action. As used in this specification, the prohibited action that users interdict is the continued development and propagation of termite superorganisms near objects or within areas that humans desire to inhabit or otherwise use for economically important, ostensibly lasting purposes.

Food Consumption: Individual Termites

The rate of food consumption varies by termite species and the kind of wood consumed. Throughout the United States, a single genus, Reticulitermes, and two species within it, R. flavipes and R. hesperus, are responsible for most of the subterranean termite damage to homes and businesses. In certain areas, particularly along the coast of the Gulf of Mexico, the Formosan termite, Coptotermes formosanus, also causes significant damage. The unique biology of this latter species produces a distinctively different superorganism. However, interdiction of this species is similar to that of R. flavipes and R. hesperus in many, if not most, respects.

For each of the two major species of subterranean termites noted above, the rate of food consumption varies from 0.015 mg to 0.2 mg, averaging about 0.08 mg per termite per day. A single unreplenished interceptor containing, for illustration purposes, 100 grams of food is, by this measure, theoretically capable of supplying the nutritional needs of around 1,125,000 termites for a single day; of 50,000 termites for 23 days; of 10,000 termites for 113 days; of 5,000 termites for 226 days; or of 3,424 termites for a full year.

The arrangement of food within a termite interceptor affects its attractiveness to subterranean termite foragers. Large volumes of food, arranged to accommodate many termites at a time, are more attractive than smaller volumes that accommodate fewer termites. When a food supply at a particular locus begins to dwindle, the number of visiting termites may drop dramatically. Termites often abandon a food supply when as much as 50% of its reserves remain untouched. For this reason, a reasonable rule of thumb is that a single unreplenished interceptor of 100 grams provides the nutritional needs of only 550,000 termites for a single day; of 50,000 termites for 11 days; of 10,000 termites for 57 days; of 5,000 termites for 113 days; or of about 1,700 termites for a full year.

A user should be able to extend the longevity of an interceptor indefinitely by replenishing its food supply from time to time. Unless inspections are carried out frequently, i.e., several times a month, it is unreasonable for an inspector to wait until its food reserves are depleted by 50% before replenishing them. A reasonable rule of thumb is to prescribe replenishments before an interceptor's reserves drop to 75% of its maximum, to lessen the risk of abandonment between inspections. According to this rule, an interceptor designed to hold, for example, 100 grams of food, that is serviced every three months, can supply the daily nutritional needs of almost 3,500 termites over a three-month period, or over 10,000 termites for one month, without replenishment. Similarly, one holding 400 grams could supply the daily nutritional needs of nearly 14,000 termites over a full three-month period without a refill.

Food Consumption: The Superorganism

Termite superorganisms, such as those associated with R. flavipes and R. Hesperus, generally range in size from 50,000 to 350,000 termite workers, though some have over a million. The average number of workers in such superorganisms is around 200,000, but termites of these species that attack homes tend to exceed the norm, and often range as large as 500,000.

Small termite superorganisms of around 50,000 workers may be juvenile (in a developmental phase, and comparably aggressive) or senile (in a waning phase, and comparably less active). Juvenile, aggressive termite superorganisms develop quickly and pose the greatest long-term risk to homes. Their rate of development varies according to the availability of food and moisture, the presence of predators, and other conditions, but a ten-fold increase in size can easily occur in a matter of a few years. For this reason, it is advantageous to intercept and interdict early in the life of a termite superorganism.

In its earliest stages, the foraging range of a juvenile, developing termite superorganism is limited to a radius that is often less than the footprint of a typical residential dwelling. Such a building, with a plurality of interceptors deployed around it, may have only one or two interceptors positioned within the foraging zone of such a superorganism. Conversely, a mature superorganism of, for example, 500,000 members, will forage over a much larger range that may include several homes at once. A plurality of interceptors positioned around any one of these homes may succeed in intercepting the superorganism in most or all of them.

Once a termite superorganism incorporates the interceptors deployed around a home into its food channel, from 1-10% of the superorganism's members may feed in them at a time. A small superorganism of 50,000 members, intercepted by a single device, may obtain as much as 10% of its nutrition from that device. Over 5,000 of its members may attempt to feed in the interceptor at any given time, but the typical worker spends only a portion of the day, and consumes only a portion of its daily nutritional needs, at a given food source, so a constant flow of termites enters and leaves the interceptors throughout the day. Over a 24-hour period, anywhere from 5-50% of the termite workers in an intercepted superorganism may pass through one or a set of incorporated interceptors.

Subterranean termite superorganisms comprising 50,000-500,000 members consume from 4-40 grams of cellulose daily. It is reasonable to expect to provide up to 10% of the nutritional needs (from 400 mg to 4 grams of cellulose) of an intercepted superorganism with a set of incorporated interceptors. This expectation prescribes that the incorporated interceptors must be capable of feeding, together, from 5,000-50,000 termite workers at a time.

For superorganisms of 50,000 members or less, incorporating two interceptors, each containing 100 grams, or a single interceptor containing 200 grams, into the superorganism's food channel meets this criterion. For large superorganisms of 500,000 members, the minimum number of incorporated interceptors rises to 20 for interceptors holding 100 grams, ten for interceptors holding 200 grams, or five for interceptors holding 400 grams of cellulose. As the number of interceptors decreases, the required feeding capacity of each interceptor increases. That capacity has two dimensions. One is the interceptor's cellulose reserve, and another is the number of feeding stations within the interceptor.

Feeding station capacity for a given termite interceptor is a function of its architecture and composition. A significant element of an interceptor's feeding station capacity is its design feeding surface area. A simple cylindrical or rectangular solid is limited in surface area by its exterior dimensions, though, over time, feeding termites expand the object's surface area by constructing interior galleries. By contrast, a permeable object containing multiple, prearranged, traversable passageways is capable of providing a large number of feeding stations at once.

Interdicting with Nematodes: General

Entomopathogenic nematodes, as a class of biologicals capable of interdicting subterranean termites, perform in that role because of the phoretic relationship they enjoy with a bacterium. Phoresy is a process whereby a hitchhiker organism attaches to a transporter organism and becomes dormant until the transporter enters a habitat conducive to rapid reproduction of the hitchhiker. Within such a habitat, the hitchhiker breaks dormancy, detaches from the transporter, and begins to multiply. In the case of entomopathogenic nematodes, the hitchhiker is a bacterium (the nematode Steinernema carpocapsae, for example, carries a bacterium in the genus Xenorhabdus) transported by the nematode in its anterior gut or in a special intestinal vesicle.

Bacteria in the genus Xenorhabdus live as phoretic symbionts in nematodes and as pathogens in insects. Nematodes need the bacteria to survive, but insects invaded by the nematodes soon die, not from the nematodes directly, but from infections caused by the phoretic bacteria the nematodes bring with them. Species of the phoretic bacteria involved are rod-shaped, facultative, anaerobic, gram-negative members of the family Enterobacteriaceae.

The Enterobacteriaceae contains some of the most pathogenic organisms known to man. However, members of this family that serve as phoretic symbionts for entomopathogenic nematodes are harmless to humans and other mammals. In fact, when certain species of these bacteria (for example, Xenorhabdus nemataphila) are injected into human wounds, the wounds normally heal quickly, presumably because antibiotics secreted by the bacteria inhibit the development of harmful microbes.

Though similar to other Enterobacteriaceae, species of Xenorhabdus tend to be bigger and do not reduce nitrates to nitrites. Species of Xenorhabdus reside in the anterior gut or in special intestinal vesicles of species of juvenile nematodes in the genus Steinernema. S. carpocapsae and S. feltiae, for example, are terrestrial, soil-dwelling nematodes that invade an insect via its spiracles, mouth, or anus.

Once inside, they migrate to the insect's blood supply, where their phoretic bacteria detach, reproduce, produce toxins that kill the insect, and secrete antibiotics that prevent putrefying bacteria from spoiling the insect cadaver. This allows the nematodes and their phoretic bacteria to thrive for days inside the insect's body after it is killed. How many days is variable, depending on the insect, the nematode, the bacteria, the temperature of the soil, and other environmental conditions. Experiments suggest a range from five to fifteen days.

Xenorhabdus spp. kill insect hosts so quickly (within 24-48 hours) that nematodes carrying them don't have to adapt to the insect's life cycle. That makes the nematode very effective against a large number of insects, including eusocial insects such as subterranean termites.

As the nematode's phoretic bacteria multiply inside an insect cadaver, they become food for the nematodes. As the mature nematodes feed on the bacterial mass, they proceed through several molts and lay eggs. After the eggs hatch, nematode larvae develop to the J3 or dauer stage, whereupon they become capable of infecting live termites. These “infectives” acquire fresh batches of phoretic bacterial hitchhikers (some of the bacteria become associated with the nematode infectives and then go dormant) and prepare to depart. Between five and seven days after the original nematodes infect a termite host, their offspring exit the host's cadaver to find and infect new termites, and the cycle starts over.

In nature, chance infections of termites by such nematodes occur from time to time. Termites deal effectively with minor infections from biological agents like fungi and bacteria, but less so with nematode infections. For example, they groom each other to remove parasites and fungal spores before such agents acquire a firm attachment, and they encase microbially-infected members in a covering of detritus to quarantine them outside the active corridors of the superorganism in an effort to contain the infection. Such encasements are excellent barriers to transmission of bacterial, viral, and fungal agents, but are comparably poor barriers to nematodes. When nematode infectives emerge from the termite cadavers several days later they are often able to gain direct access to the active corridors of the termite superorganism.

Investigators have observed that, although entomopathogenic nematode populations are highly successful as termiticides under laboratory conditions, they are sensitive to certain habitation media, to extremes in temperature, and to low humidity. Furthermore, certain fungi, bacteria and other organisms prey upon them. Based on these well-documented limitations, many investigators concluded that any effort to employ entomopathogenic nematodes for termite control will fail, at least in the long term. Because many natural environments present with fluctuating conditions of media, temperature, and humidity that are not favorable for nematode survival, and contain endemic populations of predators, such a conclusion appears warranted, at least on the surface.

Such conclusions rest, however, on the presumption that users are unable to inject, in an effective and consistent manner, nematodes directly into a termite superorganism, where termite workers carefully regulate the temperature and humidity to maintain an environment that is, coincidentally, favorable to entomopathogenic nematodes. It also presumes that users cannot provide, in the field, suitable laboratory-grade dormancy media to serve as a reservoir for nematodes waiting for a resumption of termite activity, following a successful interdiction that naturally produces a temporary quiescence. Finally, it ignores the possibility of a user reinitiating interdiction with a fresh dose of nematodes in an interceptor that previously was injected, later becomes inactive, and then resumes intercepting termite foragers.

By using interceptors designed specifically to facilitate termite interdiction with entomopathogenic nematodes, it is reasonable to expect a user to achieve results that are comparable, or even superior, to those achieved with interceptors designed for termite interdiction with toxicants alone.

Interdicting with Nematodes: Conclusions

Using entomopathogenic nematodes to control termites in the traditional manner, i.e., by flooding the perimeter of a structure with millions of infectives in hopes they will intercept and interdict any termites that intrude, represents the same kind of overkill employed with soil-drench termiticides. By comparison with chemicals, nematodes are not hazardous to children or pets that dig in the treated soil. However, the costs associated with such treatments are high and the residual value of such treatments is both limited and indeterminate. Factors such as unfavorable soil conditions, temperatures and moisture levels that are too high or too low, or the presence of fungal or bacterial predators, can quickly nullify a soil-drench nematode treatment. Worse, since the user has no practical means of determining when such nullification occurs, it is difficult or impossible to ascertain when the nematodes cease to provide a desired level of protection.

This shortcoming is partially resolved by injecting the entomopathogenic nematodes directly into the termite superorganism, whenever and wherever a means of access to that superorganism presents itself. For example, a user may inject entomopathogenic nematodes, via a syringe, into an active termite shelter tube found on a foundation wall, or into the active workings of a termite-infested section of wood in the frame of a home.

While direct injection methods are useful whenever, due to serendipity, the opportunity presents itself, they do not provide a complete solution, because alone they fail as a reliable, consistent means of interdicting active termite superorganisms.

Termite interceptors, on the other hand, provide individual injection points for nematode interdiction of termites once they intercept the termite superorganism. However, presently marketed termite interceptors fail to provide an environment conducive to habitation and propagation of nematode infectives. For example, none of the interceptors, detectors, or bait servers presently on the market—with the exception of the devices described in this specification—provides thermal and radiation insulation to protect the device from solar iuflux in the summer or from excessive heat loss in colder periods.

Furthermore, none of the interceptors, detectors, or bait servers presently on the market—with the exception of the devices described in this specification—provides one or more reservoirs containing media specially conducive to the habitation, propagation, or dormancy of entomopathogenic nematodes.

Such reservoirs, if they are to be provided at all, must be provided either within or nearby the interceptor. The general unpredictability of the soil in the field for such purposes is well known. By amending and arranging the interior contents and constituents of an interceptor, nematodes introduced within its confines may be provided with a favorable media for habitation, for host interaction, and for dormancy.

By applying entomopathogenic nematodes to interceptors that are specially insulated from excessive temperature swings, and by applying nematodes to such interceptors only while termites are actively consuming food material within the interceptor, conditions of temperature and humidity, throughout the interceptor, will remain within a narrow range that is carefully controlled by the termite workers, which range is, in general, also conducive to the habitation and propagation of entomopathogenic nematodes.

By providing a dormancy media reservoir in the ventral regions of such an interceptor, conditions of temperature and humidity there will continue to favor nematode survival for lengthy periods, even after the intercepted termite superorganism has been interdicted.

In short, by providing an interceptor with the features mentioned above, the interceptor can be made to function as a miniature laboratory, within which conditions conducive to nematode habitation, propagation, and dormancy prevail to the point that they allow entomopathogenic nematodes to perform consistently within a wide range of climates and environments as excellent interdictors of termite superorganisms. In the process, one may nullify all of the well-documented shortcomings of field applications of entomopathogenic nematodes for termite control.

Miscible Tasks: General

Miscibility allows two or more separate entities to mix or blend uniformly to achieve a homogeneous mixture. The entities involved may be liquids, solids, or tasks. We may categorize miscibility as molecular, mechanical, practical, or economical.

Miscibility in chemical and mechanical systems is well known. For example, mixing highly miscible liquids such as alcohol and water produces a mix volume that is less than the summed volumes of the separate liquids because water molecules slip into gaps between alcohol molecules. Solutions of copper and nickel mix in a similar fashion to form solid cupronickel used in today's common coinage.

Mixing fine glass beads, large irregularly shaped dry limestone rocks, and water in one vessel, demonstrates mechanical miscibility: the glass beads fill gaps between the rocks; a portion of the water fills gaps between the beads and the dry limestone absorbs the remainder.

Task mixing, also known as multitasking, where a worker executes separate, logically dissociated tasks together, is an example of practical miscibility. Task mixing that achieves an increase in efficiency and a reduction in costs is an example of economic miscibility.

Workers execute complex tasks as a series of discrete subtasks, often with significant gaps interposed between them. For example, a pest management technician who performs the inspection and servicing of the perimeter of a structure for pests repeats at least two subtasks along a physical path that commences at a starting point and ends when the worker completes the circuit and arrives back at the starting point. Each definite repetition consists of (1) traveling to a key position along the perimeter, and (2) pausing to inspect the portion of the perimeter viewable from that position for pest activity. A third, potential repetition, which may occur at any of the key positions along the perimeter, involves (3) servicing identified pests as they are found and performing preventive measures when conditions warrant.

Each inspection subtask is comprised of a variety of subordinate subtasks, such as inspecting for (2.1) wasps in the eaves, (2.2) ants in the lawn, (2.3) evidence of rodent activity, and (2.4) containers of standing water that breed mosquitoes. Potential service subtasks include (3.1) spraying wasps found in the eaves, (3.2) treating ants in the lawn, (3.3) inserting copper gauze into a probable rodent ingress hole, and (3.4) emptying and noting on the service log the existence and location of containers of standing water.

Over a full calendar year, the mix of subtasks involved with pest management services changes with the seasons. However, experienced technicians tend to take about the same time to perform general insect services at a given site, regardless of the number of subtasks involved. Such technicians are adept at task mixing because they choose the tasks they mix with care. For example, inspecting for moles takes about the same time as inspecting for fire ants and moles simultaneously. However, an experienced technician would not attempt to mix the tasks of inspecting a home's perimeter with checking and servicing a site's cryptic termite detectors. Cryptic termite detectors introduce a host of added complexities that make it difficult to mix their servicing with general insect control work.

Most tasks can be multitasked, but not all tasks are miscible. Miscible tasks are those that, when multitasked, achieve significant practical and economic advantages. As used in this specification, highly miscible tasks are those that a worker may multitask without incurring a penalty. If, for example, a worker has to service fewer customers each day in order to accommodate an added task, that task is not practically miscible. By that definition, termite baiting with cryptic termite detectors and/or bait servers is not practically miscible with general insect control services.

Another measure of miscibility is whether the added task increases costs to the point that, for many of a technician's customers, the cost-to-benefit ratio becomes unattractive. By this definition, termite baiting with cryptic termite detectors and/or bait servers is not economically miscible with those of general insect control. That is why many firms dedicate specially trained technicians to perform termite baiting for their customers. Most such firms charge, for termite baiting alone, fees that exceed those they charge for general insect services. This limits termite baiting to customers with active termite infestations. It often leads, as well, to premature termination of termite baiting contracts, by the customer, once active infestations appear resolved, even though the underlying termite superorganism continues to survive, and thrive, at the customer's site.

Miscible Tasks: Conclusions

Since its introduction in 1996, the nemesis of the termite-baiting paradigm has been the cryptic termite detector and bait server. As used in this specification, a cryptic device is one that a user cannot inspect and/or service without physically opening the device or by interrogating it with specialized auxiliary equipment. Such devices, despite the advertising claims that accompany them, waste significant quantities of time, effort, and/or capital. Threshold interfacing (the minimum needed for effective decision-making) with such devices requires physical interaction, or (in the case of detectors that utilize RFID or similar technology) extra equipment merely to determine if they need servicing. Inspectors who use such devices, including advanced “inspector-friendly” models whose caps the user can remove while standing, tire quickly and perform poorly.

Ideally, threshold interfacing with termite detection and baiting devices should.be effortless and instantaneous, and should not require the use of specialized auxiliary equipment.

### SUMMARY

This specification describes a family of devices that intercepts and interdicts subterranean termites. It discloses, in the preferred embodiment, a device that facilitates the use of entomopathogenic nematodes. Furthermore, the simplicity and elegance of this design facilitates the mixing of termite interception and interdiction with ordinary pest management services.

### DEVICES AND METHODS OF THE PRESENT INVENTION

The devices of the present invention enable new methods of insect control. First, they simplify the process of communicating to users that the interception of a target pest has occurred, or, in the case of a pest previously intercepted, that interception of that pest continues. Second, they simplify the interdiction of intercepted pests by facilitating the introduction into, and the continued supplementation thereof, of intercepting devices with specific interdiction agents.

By bringing simplicity and efficiency to the interception process, the present invention dramatically reduces the costs of termite baiting, even when professional, licensed technicians deploy its devices separately from general insect control services. However, because its tasks and those of other pest management services are highly miscible, it potentiates even greater levels of efficiency when integrated with mainstream pest management programs.

The devices disclosed in this specification are also suitable for use in a do-it-yourself (DIY) economy. A home or business owner who desires to monitor the soil and landscaped areas around a home or business for termites, may easily deploy, inspect, and service them without professional assistance for preventative monitoring and interdiction purposes.

The key devices of the present invention are unrestricted, easily serviced termite interceptors that require no special skills or training to use. However, because skilled professional users, experienced and trained in termite biology, are able to install, inspect, and service them more effectively and efficiently, only skilled professionals should employ them to deal with active structural termite infestations. Consumers, on the other hand, should feel perfectly capable of using them proactively in landscaping areas to interdict developing termite superorganisms before they are able to attack their homes. Furthermore, because customers are able to inspect these interceptors, the professional may share the inspection responsibility with a customer. For pest management companies that specialize in annual servicing, for example, the customer may inspect the installed interceptors throughout the year. The company needs to come to the customer's site only when the customer's inspections reveal that termites are present in one or more of the interceptors.

Although the methods of the present invention, along with the devices it employs, relate specifically to termite control, similar methods, augmented with devices offering similar features, apply to nearly every facet of pest management. The inventor is, in fact, designing, testing, and implementing similar devices to control rodents, cockroaches, and flying insects. Those devices are the subjects of separate patent applications that the inventor has presently filed or is preparing to file.

Progressive Placement of Termite Interceptors

The present invention is designed for installation in a progressive placement program that begins with a minimal deployment of interceptors that is augmented later with additional interceptors as needed. The object is to intercept a major proportion of the target organisms foraging within the interception zone. The interception zone is defined as the area within which the user desires protection against infestations of specific target superorganisms.

Rather than prescribing a set number of interceptors for a given length of structure perimeter, as is done with common termite detectors and bait servers, users place the interceptors of the present invention only in areas where conditions suggest the likelihood of superorganism activity. The following are indicators of where and how many interceptors of the present invention are required at a given site:

(1) The presence and quality of specific conducive conditions, such as wood-to-ground contact, submergence of masonry or other facade below grade, proximity to bath traps, hose bibs, and cold joints between adjacent foundation sections.

(2) The presence and quality of known, active termite infestations, including those in landscaping, outbuildings, fences, and woodpiles, and in previous deployments of devices of the present invention.

Once an installed interceptor signals the presence of termites, a user may service it with interdiction agents. Interdiction takes place as the result of supplying one or more interdiction agents to members of a specific insect superorganism. Individual members, though eventually incapacitated by the interdicting agent, communicate it to other regions and other members of the superorganism. Ideally, incapacitated members of the superorganism incubate and replicate the interdicting agent, so that, over time, it propagates in increasing number and vigor.

The devices of the present invention are uniquely suited for the use of biological pesticides, including entomopathogenic nematodes. Additionally, pesticide producers may formulate portioned toxicants in granular, particulate, powdered, liquid, and similar forms for use in these devices. Except where label instructions do not permit it, the user may mix biological pesticides and portionable toxicants to take advantage of the synergistic effects that such combinations afford.

Keeping every deployed interceptor supplied with interdiction agents, on an as-needed basis for as long as active interception takes place, moves interdiction forward. The rapidity of the interdiction process is under the control of the user, based on the nature of the infestation. If an intercepted superorganism is not infesting a structure, the user may choose to interdict with a minimal deployment of devices and a minimal application of interdiction agents. Structures actively infested should employ enough interceptors and interdiction agents to mount an aggressive interdiction that succeeds quickly, to prevent serious additional damage from taking place.

Because these interceptors are inspected with a minimum of effort—visually, from a standing position, at a glance while passing by—a user is able to monitor a vast interception zone, consistently and continually, without incurring short or long term physical or mental fatigue. Because they are serviced with a minimum of effort—by pouring interdiction agents into the interceptor through a signal port, and topping the interceptor up with supplemental food materials poured through the same signal port—a user is able to perform a continuing, consistent, interdiction program within a vast interception zone, again without incurring short or long term physical or mental fatigue.

### SUMMARY OF THE INVENTION

The present invention achieves technical advantages over the prior art. It does this by capitalizing on certain instinctive behaviors of specific target superorganisms, particularly those associated with eusocial insects such as subterranean termites, and by taking advantage of the ordinary visual, mental, and physical faculties of human users, using a family of interceptors/interdictors. In the process, it provides for dispensing interdiction agents, taking advantage of processes that, over time, succeed in the complete interdiction of superorganisms that enable their associated eusocial insects to infest objects of economic value.

The inspection process for the present invention requires no specialized skills and only minimal articulation of the joints. The user passes over a defined inspection circuit and simply glances at the devices of the present invention while passing nearby. If the interceptor's signal port has the same appearance as at the initial installation, the interceptor is inactive, but if the signal port shows a void, target organisms have become intercepted by the device.

Discernment of a void in the signal port of a device of the present invention occurs instantly, even when the user is standing as far as twenty to fifty feet from the device.

By placing these devices around a structure, as well as in proximity to other sources of consumable matter suitable as food for organisms targeted by the device, the user is able to discover not only the fact of the presence of target organisms at the site, but may also take a rough measure of size and dispersion.

These devices work well with quarterly pest management programs, but also work effectively with monthly, semi-annual, or even annual programs, particularly if the inspection role is shared with the customer. If a user discovers that the food matter in a deployed device has been completely depleted since the last inspection, an additional device should be deployed at that location after the depleted device has been serviced with fresh consumable matter. Later, if depletion occurs again between inspections, the user should add even more devices until depletion of the deployed devices ceases to take place. Interception without complete depletion of the food matter in the interceptor is a prerequisite for initiating and prosecuting a successful interdiction.

When deploying several interceptors of the present invention at a site, the number of interceptors that intercept target superorganisms within a given distance of one another, along with the spatial arrangement of the interceptors, provides a measure of the dispersion. The accuracy of such a measurement depends upon the number and placement of interceptors. Users who desire an accurate assay of the distribution within at a particular site should deploy more interceptors. Sites without active infestations may require no more than the minimum number, as dictated by the site's catalogue of conducive conditions.

Once an interceptor of the present invention intercepts a termite superorganism, visual changes in its dorsal surface signal that fact to a user. Even if consumption of the interceptor's food matter is minimal, the user should supplement it with an additional device. If consumption is proceeding at a high rate, so that, for example, the low-density food matter in the device has dropped 2-inches or more, more than one supplemental interceptor should be deployed nearby. After adding one or more supplemental interceptors near the signaling device, the user services the signaling interceptor with termite interdiction agents and returns it to a non-signaling state as described elsewhere in this specification.

Due to the interceptor's internal construction and the constituent materials therein, interdiction agents poured into it in liquid-suspension form are conducted at once to individual members of the target superorganism that are feeding in the interceptor, whereupon a desired effect will commence. The food matter in each device may absorb particular toxicants poured into the device through a signal port, providing residual toxicity to members that arrive afterward. The food matter in each device may also comprise media that provides a habitat suitable for nematodes or other biological pesticides to persist for long periods, even after successful interdiction of an intercepted target superorganism has occurred. In this manner, an interceptor, once treated, continues to pose a hazard to separate superorganisms that may invade it later.

After supplementing the interceptor with interdiction agents, the user replenishes its food supply and restores it to a non-signaling state by filling its dorsal cavity with fresh consumable matter. The user pours the fresh matter into each signal port, or removes the device's dorsal cover, fills the cavity, and reinstalls the dorsal cover. The user may mark the dorsal cover to show the date and the procedure performed, or may note the identifying marks on the dorsal cover in a separate log for later reference. Markings may include barcode labels.

If a desired toxicant can only be used in devices that are child or pet resistant, if the device is placed in a locale where it is frequently inundated by rainfall or irrigation equipment, or if the device is placed in direct sunlight, it may be fitted with a safety/moisture/radiation barrier. This barrier is comprised of a thin, flexible material such as aluminized Mylar. With the safety/moisture/radiation barrier in place, children and pets are unable to contact the bait material; water, introduced from above, is prevented from entering the device; and up to 95% of the solar radiation that impinges on visible portions of the barrier is reflected away from the device. Because the safety/moisture/radiation barrier mates intimately with the dorsal surface of the consumable matter within the device, the barrier moves downward with the consumable matter. Consequently, during later inspections, the downward movement of the safety/moisture/radiation barrier signals, from a distance, that the device has intercepted termites.

On subsequent visits to the site, the user examines each previously serviced interceptor for evidence of additional consumption of the food matter within it. Such evidence involves, as before, the presentation of a void at one or more of the signal ports in the dorsal surface of the device, caused by the downward movement of the added food matter. Whenever the food matter, or a safety-liner/moisture/radiant barrier disposed between said food matter and the dorsal cover of the device, recedes from contact with the dorsal cover of the interceptor, additional interdiction agents should be added, along with fresh, consumable matter that restores the device to a non-signaling state.

After a period has passed without any evidence of additional consumption of the food matter within an interceptor, one may infer that it has ceased to intercept and has reverted to the role of monitoring for new arrivals. However, because the architecture of a serviced device is dissimilar to that of a fresh one, the user should deploy a fresh device nearby to serve as a fail-safe interceptor that monitors for new termite activity.

A user may inspect the interceptors deployed at a given site while performing general pest management procedures in the course of a regular service schedule. The user services signaling devices and adds additional ones, as described above, on an as-needed basis. This sequence continues until all of the devices then deployed are functioning as either interceptors (1) that have never signaled, or (2) that have shown no signs of interception for some time. The deployed interceptors at the site thereafter continue ready to intercept, subject only to periodic replacement of obsolescent or contaminated interceptors on an as-needed basis.

Continued Monitoring and Periodic Replacement of Non-Signaling Devices

Sites that have achieved successful interdiction continue, as with every other control regimen, to be subject to future interceptions. A superorganism once considered interdicted may later rebound. Nearby superorganisms from the surrounding area that were prevented, in the past, from foraging at the site may, after a time, take over the original superorganism's workings or produce new workings of their own. Nuptial pairings of, for example, swarming termite alates from surrounding areas, may found a new superorganism where the original once foraged. For all these reasons, the user must continue ready to intercept into the future.

The appropriate replacement interval for devices of the present invention depends upon soil, hydraulic, and climatic conditions unique to each deployment site. In arid climates, these devices may survive in place for up to five years without showing signs of interior contamination. In locales with moderate levels of annual rainfall, that interval may shrink to three years or less. Devices positioned near lawn irrigation heads, in depressions where water collects, or in extremely acidic or alkaline soils, will have shorter than normal replacement intervals.

### BRIEF DESCRIPTION OF THE DRAWINGS

Note that although these drawings show a specific number of features such as signal ports and other ports, lateral passageways, vertical cavities, vestibules, inoculation reservoirs, and the like, both the number of such features as well as their exact placement may easily be varied while remaining faithful to the essential design.

Note also that although the superorganism targeted by these devices may be subterranean termites, all or a portion of a device's design may also serve to intercept a wide range of other target organisms. Thus, while the food matter within a device of the design detailed herein may comprise cellulose or other food matter particularly attractive to termites, such food matter may also be substituted with other materials specifically attractive to others.

References herein to biological habitation media refer to amendments, included in the device at its initial deployment and/or added during subsequent servicing thereof, that are conducive to the habitation, flourishing, and retention of specific biologicals such as nematodes. However, such media may be modified to facilitate using the interceptor with other biologicals, such as fungi, bacteria, or other microbials in interdiction regimens meant to infect, intoxicate, or otherwise afflict specific target superorganisms intercepted by the device, as well as by biological or non-biological markers.

FIG. 1 is a perspective view of a preferred embodiment of the exterior of a termite interceptor of the present invention with an outer lateral body member, a plurality of lateral ingress/egress ports, a dorsal cover having a plurality of dorsal signal ports that are, mechanically, in communication with the lateral ingress/egress ports via a plurality of interior vertical and lateral passageways, and a safety/moisture/radiation membrane sandwiched between the dorsal cover and the interior contents;

FIG. 2 is a perspective cut-away view of a preferred embodiment of an interceptor of the present invention showing a ventral cover not visible in FIG. 1, revealing additional features of the safety/moisture/radiation membrane sandwiched between the dorsal cover and the interior contents, and showing the elements comprising the interior, including: a lateral liner attractive to termites but neutral or unattractive to other organisms that may come into contact with it, a plurality of ventral dispersal disks that enclose one or more biological habitation reservoirs with biological habitation media sealed between them, a lateral low-density bait in mechanical communication with the liner and the dorsal signal ports, a lateral medium-density bait between the low-density bait and a central core of high-density bait, with space for biological habitation media to be included within the low-density, and sealed within the medium-density, baits, if desired.

FIG. 3 is a perspective cut-away view of a preferred embodiment of an interceptor of the present invention as it appears after it has intercepted termites within its interior food matter. Termite foragers, finding the matter comprising the liner attractive for food, have violated said liner, progressed to, and violated the ventral dispersal disks, partially consuming them and penetrating the biological habitation reservoirs. A residue, rich in biological habitation media, has also accumulated in the ventral region of the interceptor's low-density bait. As long as termites continue to feed in the interceptor, they will take steps to regulate moisture and temperature levels within the portions of the interceptor where feeding takes place.

The dorsal extremity of the interceptor's low-density bait has slumped downward, causing the safety/moisture/radiation membrane to fail to maintain its former intimacy with the signal ports. This produces a marked change in the visual appearance of the signal ports by producing a cavity below them. This visual change signals to a user the presence of termites within the device.

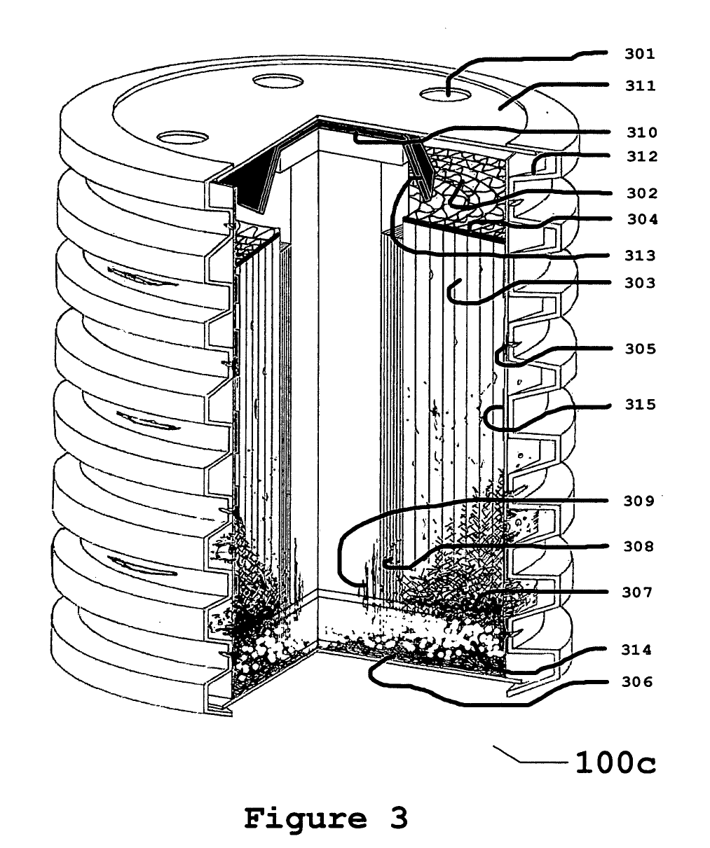

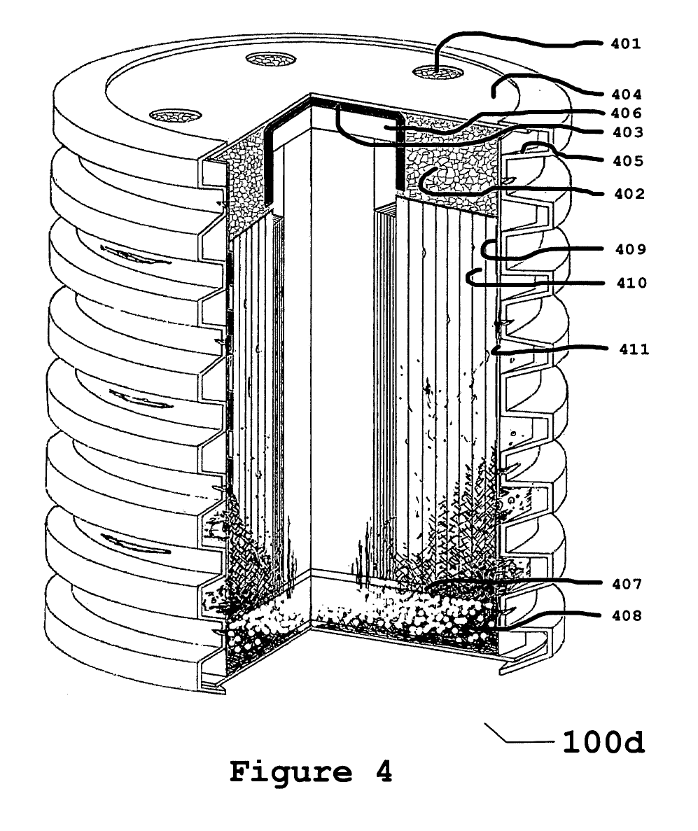

Termite foragers have violated the medium-density bait of FIG. 3 laterally, causing a residue rich in biological habitation media to accumulate in its ventral portion. The termite foragers have also violated the high-density bait laterally. Termite foragers will continue violating the interceptor until they consume all or a substantial portion of its interior food matter.

FIG. 4 is a perspective cut-away view of a preferred embodiment of an interceptor of the present invention as it appears following (1) servicing of the interceptor with interdiction agents, followed by (2) supplementation of the interceptor's interior food matter to bring the interceptor to a non-signaling, serviced state, whose signal ports no longer show a cavity below them. As termites continue to feed inside this serviced interceptor, the low-density bait beneath its signal ports will slump again, creating a new cavity that signals the need for additional servicing in a manner identical to that described above. An interceptor serviced serially in this manner continues to perform in the role of an active termite interceptor until termite activity ceases. At that point, the interceptor reverts to the status of a monitor.

### DETAILED DESCRIPTION OF THE PRESENT INVENTION

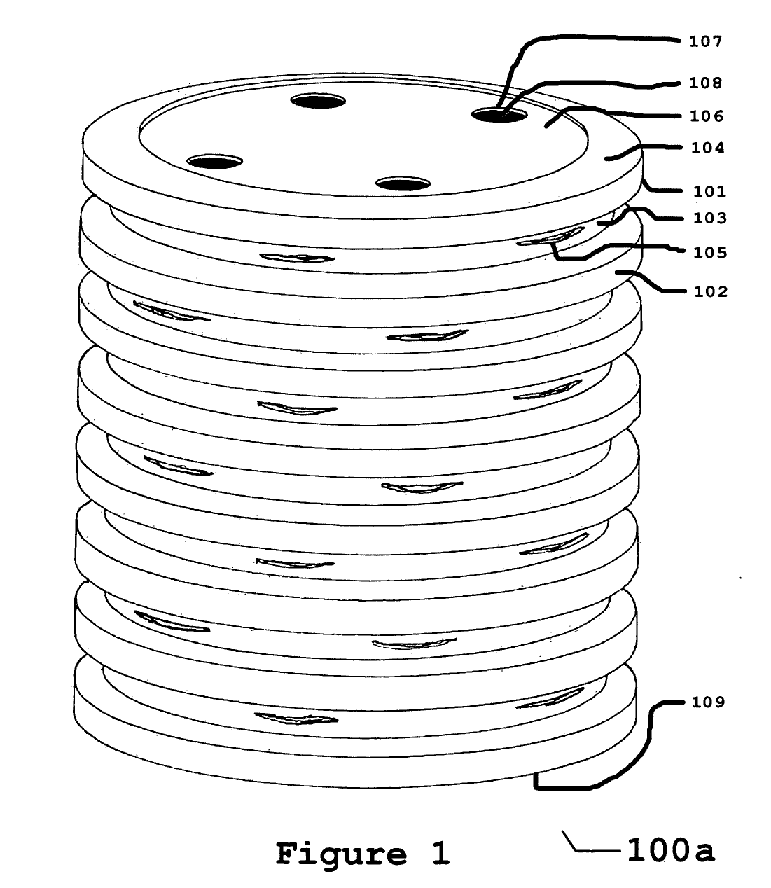

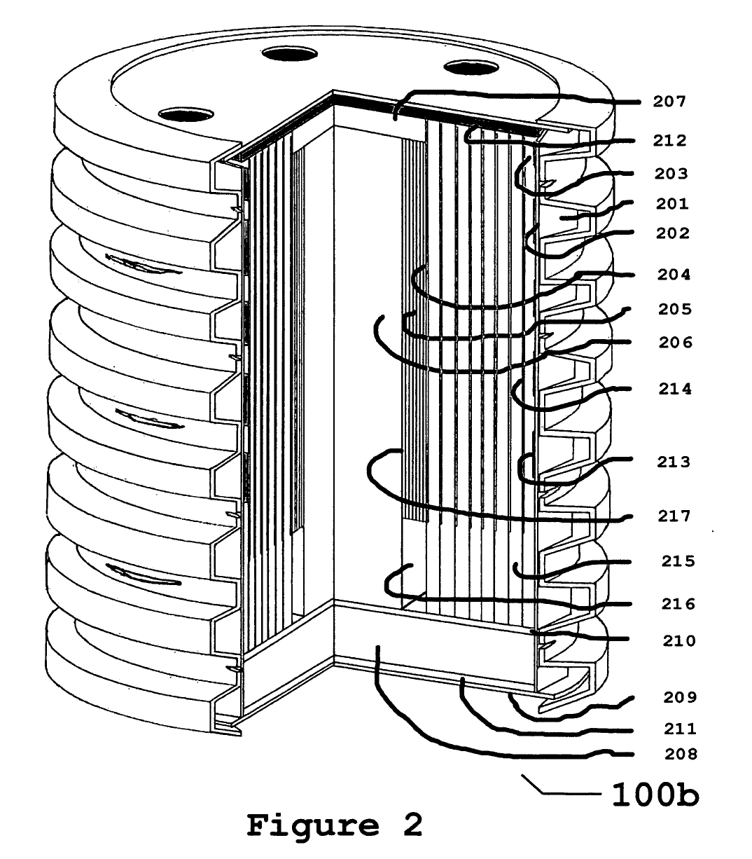

FIG. 1 illustrates a preferred embodiment of an interceptor 100 shown at 100a. The interceptor is comprised of a laterally disposed body member 101 that protects the device's lateral aspect, a cover 106 that protects the device's dorsal aspect, and a cover 109, not shown directly in this figure but visible in FIGS. 2-4, that protects the device's ventral aspect. These protective elements are comprised of tough, durable, semi-rigid materials that cannot be penetrated by botanical structures such as roots of trees or shrubs, and do not degrade in contact with water, soil, or sunlight.

The architecture of body member 101 may be a simple cylinder or polygon that opens dorsally and/or ventrally and that may have a flange 104 at its dorsal and/or ventral aspect to hold covers 106 and/or 109 in place. Body member 101 may have a straight, unbroken vertical dimension, or its vertical dimension may be broken, singly or plurally, with vertical or concentric corrugations or other regular or random non-linear structures 102. These structures 102 serve to increase the rigidity of body member 101, limit its flexibility, provide interior and/or exterior cavities, and/or assist in anchoring the interceptor once it is submerged in a medium such as sand, soil, asphalt, or concrete.

Body member 101 contains one or a plurality of lateral ingress/egress ports 105 in the portion of its surface 103, for example in the ridge of a corrugation, which is in intimate contact with a lateral surface of at least one of the interceptor's interior elements. Termites gain access to the interior elements of the interceptor by entering through lateral ingress/egress port 105.

Dorsal cover 106 is removably attached to body member 101 in such a way that, while in place, it completely covers the interceptor's dorsal aspect. Dorsal cover 106 contains one or a plurality of signal ports 107, which allow an observer, from a distance, to inspect the status of the dorsal surface of at least one of the interceptor's interior elements 108. As long as the dorsal surface of the visible portion of the interceptor's interior element 108 is observed to be in intimate contact with dorsal cover 106, the interceptor is not signaling the interception of termites therein. When dorsal cover 106 and the visible portion of the interceptor's interior element 108 are observed not to be in intimate association with one another, the device signals interception.

FIG. 2 illustrates the details of the interior elements of a preferred embodiment of device 100, including ventral cover 209, as shown at 100b. A casual observer will note that a wide variety of other interior arrangements is possible while retaining the device's essential character and functionality. A liner 202, whose lateral surface 201 is decoupled from the inner surface of the device's body member, is comprised of a semi-durable material, such as heavy cardboard, cardboard in association with a layer or membrane of other material such as thin plastic sheet, or another semi-durable matter selectively attractive to termites but unattractive or neutral to organisms not targeted by the device. A portion the lateral surface 201 of liner 202 is exposed at each ingress/egress port of interceptor 100.

Low-density bait 203 may be in contact with, but is not attached to, liner 202, and in fact a gap normally separates these two elements. Decoupling bands 213 are disposed around the exterior of low-density bait 203 to insure, even under high-moisture conditions, a physical separation between low-density bait 203 and liner 202, so that vertical movement of the bait within the device is not impeded. Low-density bait 203 is comprised of semi-durable food material. If xylophagous organisms are targeted, this material may, for example, be comprised of thin-walled single-faced corrugated cardboard, large, low-density cellulose granules, or loosely packed low-density cellulose particles.

Vertical density of low-density bait 203 may vary as needed to assist in slumping of the bait mass when it is violated by termites. For example, more dense bait sheet 214 may be disposed in the upper regions of low-density bait 203 and absent in the ventral collapsible region 215, so that, as termites consume the cellulose bait in the latter region, the weight of the bait mass above it will cause the bait mass to collapse downward.

The architecture of low-density bait 203 is such that it provides an abundance of passageways or interstitial spaces that communicate vertically and/or laterally between the dorsal and ventral regions of interceptor 100, to facilitate the vertical and lateral movements of organisms that enter them, providing a significant initial feeding capacity. Low-density bait 203 may consist of structures, granules, or particles that are, for example, easily navigated and/or penetrated by termites. Thus, low-density bait 203 also facilitates the lateral movement of such organisms within its extent, though those passageways and/or interstitial spaces may be filled, partially or fully, with biological habitation media such as fine sand or other material specifically conducive to the habitation, propagation, and retention of certain biological pesticides.

The dorsal extremity of low-density bait 203 is in intimate contact with the underside of safety/moisture/radiation barrier 212, which is sandwiched between low-density bait 203 and device 100's dorsal cover. Safety/moisture/radiation barrier 212 is comprised of a flexible, durable, impenetrable material suitable as a single, dual, or triple barrier between the interior of device 100 and hazards to the device or to others through its signal ports.

For example, when toxins are deployed in device 100, safety barrier 212 is comprised of a child and pet resistant material that prevents children and/or pets from making contact with the toxic material inside. In locales subject to rainfall, or near sprinkler heads or similar water-dispensing devices, moisture barrier 212 is comprised of a waterproof medium that prevents moisture collecting on the dorsal cover of device 100 from entering the device interior. In locales subject to direct sunlight or other sources of radiant or thermal influx, radiant barrier 212 is comprised of material that reflects radiation, or that blocks conduction of thermal energy, and thus insulates the interior of device 100 from excess temperatures. In deployments where more than one hazard applies, safety/moisture/radiant barrier 212 is comprised of material that performs multiple finctions, as required for that specific deployment.

Safety/moisture/radiation barrier 212 is optional in certain uses of the preferred embodiment. It may be omitted where barriers to safety (device 100 does not contain toxic materials accessible through its signal port), moisture (device 100 is not deployed in locales subject to rainfall or other airborne water sources such as nearby sprinkler system heads), and radiation (device 100 is not deployed so that its dorsal surfaces receive direct sunlight or other forms of thermal influx) are not necessary.

When present, safety/moisture/radiation barrier 212 comprises a flexible, durable, and impenetrable material that is separate from but rests upon the dorsal surface of low-density bait 203, so that low-density bait 203 sandwiches safety/moisture/radiation barrier 212 between it and the dorsal cover of device 100. In this position, material 212 comprises, prior to installation, a seal that prevents any loose matter, including biological habitation media that may be contained within the structures of low-density bait material 203 from being displaced to the exterior of the device through a signal port during shipping and handling.

That portion of bait 203 (if safety/moisture/radiation barrier 212 is not present) or of safety/moisture/radiation barrier 212 (if present) that is visible through a signal port, allows an observer to discern, from a distance, while in a standing position, if the intimate contact between the device's low-density bait 203 and its dorsal cover is or is not maintained.

The ventral extremity of low-density bait 203 is in intimate contact with the dorsal surface of upper ventral dispersion member 210, which may be singly placed, or stacked on one or a plurality of middle or lower ventral dispersion member(s) 211. Upper ventral dispersion member 210 is comprised of semi-durable material such as corrugated cardboard, a plurality of granules, or a plurality of particles, whose architecture or composition provides an abundance of passageways or interstitial spaces to facilitate the movement of organisms within the ventral regions of the interceptor. Middle or lower ventral dispersion member 211 may be comprised of material that may be unlike, similar, or identical, to that of upper ventral dispersion member 210, and may contain biological habitation media 208, suitable for habitation, propagation, and dormancy of biological pesticides, interposed between it and ventral dispersion member 210 or between a plurality of middle or lower ventral dispersion members 211.

Medium-density bait 204 is attached to low-density bait 203, and is comprised of semi-durable material, attractive as food by target organisms. For example, in the case that the device targets xylophagous organisms, medium-density bait 204 may be comprised of heavy cardboard sheet, medium density granular, or medium-density particulate matter. Its architecture is such that it contains proportionately fewer passageways or interstitial spaces, and correspondingly more consumable food matter, per unit of volume, than low-density bait 203. A consequence of this is that target organisms will consume the mass provided by medium-density bait 204 less rapidly than that of low-density bait 203, and will, therefore, tend to inhabit that portion of device 100 later and for a longer period than the portion of device 100 containing low-density bait 203.

Together, low-density bait 203 and medium-density bait 204 comprise a collapsible bait mass. They are mechanically coupled, so that their combined weight assists in collapsing the bait mass downward as termites consume the ventral collapsible region 215 of low-density bait 203. A collapsible region 216, below medium-density bait 204, insures that collapse of the bait mass is not impeded. A casual observer will note that this arrangement may be managed in a number of different ways while remaining true to the essential nature of the device.

The passageways and/or interstitial spaces provided within medium-density bait 204 at 205 are either open or filled, partially or fully, with biological habitation media that may be unlike, similar, or identical to biological habitation media 208.

High-density bait 206 may be in contact with but is not attached to and is mechanically decoupled from medium-density bait 204 at interface 217, so that the bait mass comprised of low-density bait 203 and medium-density bait 204, aided by decoupling bands 214, is allowed to move freely in the vertical axis, without being impeded by a connection with high-density bait 206. Either or both medium-density bait 204 and high-density bait 206 are insulated dorsally from safety/moisture/radiation barrier 212 by thermal insulator 207.

Thermal insulator 207 is comprised of material that impedes the conduction of thermal energy, such as polyurethane foam or any of a number of similar, durable materials. Thermal insulator 207 serves to prevent heat transfer from the dorsal surface of device 100 to either or both medium-density bait 204 and high-density bait 206, to avoid high diurnal temperatures in device 100 when said device is deployed in locations subject to direct sunlight.

By insulating the medium-and-high-density bait materials in device 100 from the temperature extremes that occur diurnally at the dorsal 10 cover of device 100, these bait materials serve to modulate temperatures within the device throughout the day. This helps to insure that conditions inside the device are kept within the range of temperature and humidity required by both the target organisms and any entomopathogenic organisms deployed in the device to interdict them.

High-density bait 206 is comprised of semi-durable material, attractive as food by target organisms. In case the device targets xylophagous organisms, for example, high-density bait 206 may be comprised of a block of wood, a series of wooden blocks or slats joined or pressed together, or a quantity of high density granular or particulate matter.

High-density bait 206 has proportionately fewer passageways and/or interstitial spaces than medium-density bait material 204, and contains more consumable matter per unit of volume. Target organisms will, therefore, consume the mass provided by high-density bait material 206 less rapidly, and will commence feeding on the consumable material at this portion of the device last, and for a longer period of time, than in those portions of device 100 occupied by medium-density bait 204 or low-density bait 203. The passageways and/or interstitial spaces provided within high-density bait 206, if any, are either fully open, or filled partially or fully with biological habitation media that may be unlike, similar, or identical to that of biological habitation media 208.

FIG. 3 illustrates the details of the interior elements of a preferred embodiment of device 100 as shown at 100c, wherein target organisms have violated the device interior and consumed a portion of the bait material therein. The organisms have penetrated liner 305 at several ingress/egress ports, and have begun to consume the device's low-density bait material such that a portion of the bait material has been reduced to undifferentiated, compact residue 307.

Because the upper ventral dispersion member is comprised of matter suitable for food to target organisms, the organisms that violate low-density bait 303 also violate the upper ventral dispersion member at its ventral extremity, and proceed into the biological habitation reservoir 314, to consume a portion of the biological habitation media therein. In the process, the target organisms tunnel throughout biological habitation reservoir 314, all the way to middle or lower ventral dispersion member 306.

The biological habitation media in low-density bait 305 and in biological habitation reservoir 314 produce, initially and after being violated by termites, an undifferentiated, compact residue rich in matter suitable for retention and development of entomopathogenic organisms, such as nematodes in the genus Steinernema or Heterorhabditis. This matter includes, for example, finely divided sand and/or particulate clay, expanded rhyolite, and hydrated phlogopite mica. The inventor is actively testing a variety of additional materials for inclusion in this reservoir and for infusion into other portions of device 100 as well. The compacted portion of low-density bait material 303, in particular the ventral collapsible region shown at 215 in FIG. 2, no longer holds up that portion of the bait mass comprised of low-density bait material 303 and medium density bait 308. This bait mass, aided by decoupling bands 315, moves freely on the vertical axis.

A consequence of this is that the intact portion of the bait mass comprised of low-density bait material 303, and medium density bait 308, has dropped ventrally, vacating its prior position of intimacy with safety/moisture/radiation barrier 313, creating cavity 302. The high density bait material has not been substantially violated as yet, and continues in its previous position of intimacy with the safety/moisture/radiation barrier 313, through a thermal insulator positioned at its dorsal extremity, at 310.

Safety/moisture/radiation barrier 313 is comprised of a material that flexes under its own weight, and may be weighted at critical points along its periphery to aid in the flexion of the material. Because of this, it slumps downward into cavity 302. When an upright observer, from a distance, views signal port 301 of device 100, dorsal surface 304 of low-density bait 303 will clearly not be in intimate contact with dorsal cover 311. That fact constitutes a first-order signal to the observer that target organisms are feeding inside device 100.

Dorsal cover 311 is no longer in intimate contact with the dorsal surface 304 of the low-density bait, but remains held in its original position in device 100 by the continued vertical integrity of liner 305, the continued vertical integrity of the high-density bait material 309, and the continued vertical integrity of the thermal insulator positioned above the medium-density and high-density bait materials.

Device 100 is designed to cause target organisms to conduct a progressive violation of all portions of the device containing consumable matter, unless it is replenished with fresh consumable matter. As shown in FIG. 3, termites have violated portions of liner 305, and have penetrated into the interceptor's medium-density bait material at 308, into the interceptor's high-density bait material at 309, and into the biological habitation reservoir 314.

As target organisms consume more of these consumable materials, the vertical integrity originally provided by liner 305 and high-density bait 309 will grow progressively weak until they fail to hold up dorsal cover 311. If device 100 is not serviced, and its consumable matter replenished, before the vertical integrity of these elements is lost, dorsal cover 311 will drop under its own weight. Device 100 may or may not contain a lower extent shelf 312, beyond which dorsal cover 311 cannot drop, but the fact that dorsal cover 311 has dropped as much as one-eighth of an inch is obvious to an upright observer, from a distance. That observation constitutes a second-order signal of an advanced state of consumption of the liner, and of the medium-and-high-density bait materials of device 100 to the point where little or none of the original consumable matter of the device remains intact.

The observation of either a first-order or a second-order signal from device 100 informs the user that the device has intercepted target organisms. A second-order signal further informs a user that a significant portion of the original bait of the device has been violated and compacted by said target organisms. The observation of a second-order signal soon after deployment of device 100 indicates the existence of an unusually vigorous colony of target organisms at the deployment site.

FIG. 4 illustrates the details of the interior elements of a preferred embodiment of device 100 of the present invention shown at 100d, wherein a previously signaling device has been serviced and, thereafter, restored to a non-signaling state. For a reasonable period following such servicing, the serviced device is assumed to continue as an interceptor of target organisms. However, a device 100 that remains in place without further changes in its interior food matter has ceased to intercept target organisms. At that point, it reverts to the role of monitoring for future interceptions, albeit with another fresh interceptor installed nearby to insure that termites foraging in the area will be intercepted even if the initially-deployed interceptor has become contaminated in some way.

The cavity between dorsal cover 404, and the bait material in the device that has slumped downward, has been replenished with consumable matter 402, which matter may be flowable, as in a gel-based preparation, a flowable granule, or a particulate portionable material. Consumable matter may also be of pre-formed solid, or rolled, stranded, carded, formable, and/or malleable matter suitable to target organisms for food.

A user may introduce flowable matter into device 100 through signal port 401 using a funnel and/or a syringe, without removing dorsal cover 404. If a funnel is used, the funnel may be uniquely designed to work specifically with device 100, having, for example, a shortened spout that extends no further than, or only a minimal distance beyond, the thickness of dorsal cover 404. If the distal outside diameter of the funnel spout is slightly larger the diameter of signal port 401, and the proximal outside diameter of the funnel spout is proximate, or identical, to the diameter of signal port 401, this unique funnel may be snapped into signal port 401 to facilitate hands-free use of the funnel during introduction of interdiction agents and replenishment of the device's consumable matter.

Once this unique funnel is snapped into signal port 401 the user may rotate dorsal cover 404 progressively during the introduction of interdiction agents to insure the distribution of those agents to all portions of the device interior. If signal port 401 is positioned near the outside perimeter of the device, interdiction agents introduced through it will be concentrated along this perimeter. Furthermore, because low-density bait 410 is fitted with decoupling bands 409, a gap exists between low-density bait 410 and liner 411, allowing introduced interdiction agents to flow into that gap, concentrating them in the outermost perimeter of the device interior precisely where subterranean termites enter and leave the device. This arrangement positions the interdiction agents to interact with every subterranean termite that is presently in, or that enters, the interceptor, because none may enter or leave without passing through this perimeter area.

As interdiction agents such as entomopathogenic nematodes exploit the termite workers entering and leaving the interceptor, they are removed from the interdiction reservoir and carried out of the device and into the workings of the subterranean termite superorganism. Those remaining consist of juvenile infectives that are (1) indisposed to function, for the moment, as interdicting agents, or (2) unable to find suitable hosts. Such nematodes will gravitate into the ventral regions of the device, eventually passing through upper ventral dispersion member 407 that subterranean termites previously violated, and thence into biological habitation media 408.

Within biological habitation media 408 the nematodes may enter a state of dormancy, or may continue to develop to the stage where they become disposed to function as interdictors. Studies show that, in every batch of infective juvenile entomopathogenic nematodes, a certain fraction will initially fail to actively seek out hosts. Causes for this condition are poorly understood, but evidence suggests that some develop more slowly than others and, in time, they will become aggressive in their host-finding. Studies suggest that less aggressive nematodes often live longer and achieve a state of dormancy when placed in a supportive media. Such dormant organisms later emerge to aggressively seek out hosts nearby. Thus the establishment of a supportive biological habitation media 408, in the ventral region of device 100, is an essential element in maintaining the interdiction process.

After introducing interdicting agents into one signal port 401, the user may use the funnel and rotate dorsal cover 404 progressively while introducing additional agents until all the interdiction agent intended for this device has been introduced. At that point fresh consumable matter is introduced into the device through the same signal port to insure that all portions of the cavity are filled and fully replenished, without leaving any voids in the cavity.

Because the funnel spout extends just below the thickness of dorsal cover 404, the surface of the consumable matter introduced into device 100 will be flush with that of the ventral surface of dorsal cover 404. Thus, after replenishment, the user may continue performing the basic inspection protocol of determining, by visual inspection while at a standing position from a distance, if the surface of the matter in the interior of device 100 is in intimate contact with its dorsal cover 404 (no termites are present) or has collapsed downward, away from dorsal cover 404 (termites have continued feeding in the device).

Interdiction of target organisms using device 100 may involve the use of toxicants such as the chitin synthesis inhibitors hexaflumuron, noviflumuron, diflubenzuron, etc., non-repellant pesticides such as imidacloprid, fipronil, or chlorfenapyr, or biological pesticides such as the fungus Metarhizium anisopliae, the bacterium Bacillus thuringiensis, or entomopathogenic nematodes, for example those in the genus Steinernema or Heterorhabditis.

Matter 402 may contain markers, biological pesticides, entomopathogenic organisms and/or toxicants. Besides pouring through signal port 401, matter 402 may also be introduced into device 100 by first removing dorsal cover 404, inserting matter 402, and thereafter replacing dorsal cover 404.

If matter 402 is of a material labeled by its producer in such a way that prohibits its use in a device that permits children or pets to contact any portion of it, safety/moisture/radiation barrier 403 must be repositioned so that it fits between matter 402 and dorsal cover 404. Safety/moisture/radiation barrier 403 is comprised of a durable, impenetrable material that can be made to rest on the dorsal surface of matter 402 to prevent children or pets from contacting matter 402 through signal port 401, and thus render device 100 child and pet resistant.

Once device 100 has intercepted social organisms such as termites, the intercepted organisms will act to regulate temperature and humidity within the device, thereby reducing the need for the supplemental moisture and radiation barrier afforded by safety/moisture/radiation barrier 403. For that reason, in many cases servicing of device 100 with matter 402 that is non-toxic does not require removal of dorsal cover 404 and repositioning of safety/moisture/radiation barrier 403. During replenishment with matter 402 the weight of matter 402 will push barrier 403 downward, out of its way. Thermal insulator 406 remains in position, to help prevent conduction of high temperatures from a dorsal cover irradiated by direct sunlight into the lower reaches of device 100.

Continued interception of target organisms within device 100 will result in further changes to its interior food matter and collapse of the added matter 402 downward, away from dorsal cover 404. Because a repositioned safety/moisture/radiation barrier 403 rests upon matter 402, it collapses downward with matter 402. An observation that matter 402 or barrier 403 is no longer in contact with dorsal cover 404 constitutes a first order signal that target organism interception continues and that the interceptor is in need of servicing again. If depletion of the food matter in the interceptor proceeds to the point where the high-density bait collapses and dorsal cover 404 drops, the observation that it had done so constitutes a second order signal that termite activity continues and that the interceptor is in need of servicing again. Servicing of the interceptor, as previously described, continues as long as inspections reveal resumption of space between dorsal cover 404 and matter 402 or barrier 403 during subsequent inspections.

### FIELD VALIDATION OF THE PRESENT INVENTION

The present invention is the product of a program of research and development that was begun in 1988, following the withdrawal of cyclodiene termiticides by the EPA. The initial emphasis of that R&D effort was on designing devices capable of (1) intercepting subterranean termites inhabiting the soil around structures and (2) transmitting a clear, unambiguous, visual signal, observable from a distance by an upright inspector, soon after such interceptions occur.

The design disclosed in this specification, as that design applies to intercepting subterranean termites and signaling the fact of such interceptions to an outside observer without requiring the observer to physically open the device, has undergone extensive field testing in Texas. Tests conducted at field sites in Austin, Round Rock, Georgetown, Temple, Dallas, Fort Worth, Brownwood, Marlin, Cameron, Palestine, Mount Pleasant, Midland, Odessa, and San Antonio have shown that the basic design intercepts and signals as intended with a variety of subterranean termite species, including Reticulitermes flavipes, R. virginicus, and R. hageni.

After resolving the issues of interception and signaling the emphasis shifted to termite control methodology. What the inventor sought was a method of controlling subterranean termites that was as simple and elegant as the method previously developed for intercepting them and annunciating their presence. Serious roadblocks were immediately encountered. Restrictions on the use of chemicals for termite control rule them out in any methodology that claims to resemble either simplicity or elegance. The same is true of most biological agents, including the entomopathogenic fungus Metarhizium anisopliae, or the bacterium Bacillus thuringiensus.

Entomopathogenic nematodes are the exception, because these multicellular, beneficial organisms are exempt from regulation as pesticides. That exception begs a question. Is the lack of regulation due strictly to their inherent safety? Or are they, as many suggest, not only harmless to humans and their pets, but ineffective in the role of controlling subterranean termites as well? While most investigators in academia praise the ability of such nematodes to control termites under laboratory conditions, all are much less enthusiastic about their performance in the field. In the course of numerous scientific investigations, entomopathogenic nematodes have not fared well.

As the inventor perused the literature on this subject he was struck by the fact that nearly all of the field studies involved uncontrolled conditions of moisture, temperature, soil pH, and the presence of subterranean termites. That made sense if the object was to show the ability of entomopathogenic nematodes to control termites in a completely natural setting without providing them any advantages. However, one has only to control one of these factors, specifically the presence of termites, to effect a crucial alteration in direct favor of the nematodes.

It occurred to the inventor that the best means to effect this control is to provide an interceptor that would concentrate subterranean termites in an environment conducive to their continued feeding over a lengthy period of time. Such an interceptor, serving as an inoculation reservoir, would promote conditions of moisture, temperature, and soil pH that are regulated and maintained by the subterranean termites. This would effectively reproduce a number of favorable laboratory conditions in the field, and potentially resolve most impediments to the use of entomopathogenic nematodes for termite control. Designing the interceptor to position the inoculated nematodes to interface with all the termites that entered or left the device would simplify host-finding and speed interdiction of the termite superorganism. Reserving a portion of the interceptor for habitation, propagation, and dormancy of nematode infectives would extend the period of each interdiction event.

The present invention incorporates each of these features.

Extensive field evaluations of this design, using the entomopathogenic nematodes Steinernema carpocapsae and S. feltiae as interdicting agents, are presently underway. Residential single family and multifamily homes, as well as nursing facilities, shopping centers, public schools, and municipal parks are included in this evaluation. The specific sites involved are scattered over a broad geographic area of Texas, including Austin, Round Rock, Temple, Marlin, Cameron, Rockdale, Palestine, and San Antonio. Each of the sites included in this evaluation presented, initially, with active structural infestations by subterranean termites.

Field data collected thus far indicate that, when introduced in controlled amounts of, for example, 4,000,000 nematodes for each signaling interceptor, the entomopathogenic nematodes succeed in mounting a continued interdiction against termite superorganisms for a considerable period afterward. By producing successive waves of second, third, and subsequent generations of nematode infectives, spaced five to ten days apart, the nematodes weaken the termite superorganism's social structure and eventually destroy it.

The family of devices herein described have been shown to accurately and unambiguously signal the interception of targeted organisms to a user possessing ordinary visual acuity, who is standing upright, at some distance away. The features incorporated into these devices enable a user to interdict intercepted organisms with toxicants and/or biological pesticides, and to restore the device to a non-signaling state, quickly and easily. The inventor has installed, inspected, and serviced numerous prototypes of the present invention at sites throughout central Texas, and has proved, thereby, that the processes of installing, inspecting, and servicing them does not add appreciably to the time spent at ordinary service calls performed for general pest management purposes.

What is claimed is:

1. A device, comprising: a bait material attractive to wood destroying insects, a laterally disposed body member impenetrable by the wood destroying insects, the body member having at least one ingress/egress port therein permitting access to said bait material by the wood destroying insects, and having a liner disposed between the bait material and the ingress/egress port configured to permit the passage of xylophagous organisms therethrough and exclude non-xylophagous organisms passing therepast, and having an impenetrable dorsal cover, wherein the dorsal cover has at least one signal port.

2. The device as specified in claim 1, wherein a safety/moisture/radiation barrier that is impenetrable by children or pets, impenetrable by moisture, and reflects or thermally insulates against radiant energy, is disposed between the bait material and the dorsal cover, such that said safety/moisture/radiation barrier rests upon said bait material.

3. The device as specified in claim 1, wherein, when the dorsal cover is positioned at the upper limits of its range of motion, and the dorsal surface of the bait material is proximate the dorsal cover, the device does not signal the interception of target organisms.

4. The device as specified in claim 1, such that when a portion of the dorsal surface of the bait material is not proximate the dorsal cover, the device signals the interception of target organisms.

5. The device as specified in claim 1, such that when the dorsal cover is not positioned at the upper limits of its range of motion the device signals that intercepted target organisms have violated, consumed, and/or compacted a substantial portion of the bait material.

6. The device as specified in claim 1, wherein the material of the liner disposed across the ingress/egress port comprises a material attractive to xylophagous organisms such as subterranean termites, but is neutral or unattractive to other organisms and, therefore, serves as a barrier to their entry into the interior of the device.

7. The device as specified in claim 1, wherein the bait material is comprised of a plurality of bait materials distinguished by varying densities and/or masses, which are so arranged as to induce target organisms to consume the bait material in a progressive manner that produces a series of effects which signal important characteristics of the intercepted organisms to an outside observer.

8. The device as specified in claim 1, wherein the bait material, on being violated, consumed, and/or compacted by target organisms, thereafter slumps, shrinks, drops or collapses.

9. The device as specified in claim 1, wherein a portion of the bait material is of low density and/or mass when compared with the remaining portion of the bait material.

10. The device as specified in claim 1, wherein a portion of the bait material is of high density and/or mass when compared with the remaining portion of the bait material.

11. The device as specified in claim 1, wherein the bait material therein is supplemented or amended, by for example fine sand, sterile clay, or other media, which media are conducive to the habitation, propagation, and/or retention of organisms such as entomopathogenic nematodes, which amendments may also be provided in one or a plurality of special, separate reservoirs within the device.

12. The device as specified in claim 1, wherein a portion of the bait material is frictionally or adhesively sealed to limit displacement of any supplements or amendments thereto.

13. The device as specified in claim 1 wherein toxicants and/or biological pesticides are applied by a pouring, an insertion, or a placement of such toxicants and/or biological pesticides through a signal port.

14. The device as specified in claim 1 wherein toxicants and/or biological pesticides, and/or supplemental bait material matter are applied by pouring, injecting, stuffing, or pressing into a cavity between the dorsal plane of the device and the upper surfaces of the bait material.

15. A method, comprising: the graduated deployment of devices of the present invention at a site and the placement of said devices according to criteria implicit in the nature of the interdiction means.

16. The method as specified in claim 15 wherein the seminal deployment of devices is based on conditions conducive to the propagation of target organisms at said site.

17. The method as specified in claim 15 wherein the seminal deployment of devices is based on evidence of target organisms at said site.

18. The method as specified in claim 15 wherein the secondary and subsequent deployment of devices are based on the interception of target organisms by devices deployed at said site.

19. The method as specified in claim 15, wherein devices are placed at a site in locations that protect them from excessive diurnal and seasonal fluctuations in environmental conditions.
